(19) United States
(12) Patent Application Publication
(10) Pub. No.: US 2015/0153510 A1
(43) Pub. Date: Jun. 4, 2015

(54) GLASS OPTICAL WAVEGUIDE BODY AND COVER GLASS

(71) Applicant: ASAHI GLASS COMPANY, LIMITED, Tokyo (JP)

(72) Inventors: Seiki OHARA, Tokyo (JP); Tomoharu HASEGAWA, Tokyo (JP)

(73) Assignee: ASAHI GLASS COMPANY, LIMITED, Tokyo (JP)

(21) Appl. No.: 14/616,127

(22) Filed: Feb. 6, 2015

Related U.S. Application Data
(63) Continuation of application No. PCT/JP2013/069552, filed on Jul. 18, 2013.

(30) Foreign Application Priority Data
Aug. 8, 2012 (JP) 2012-176325

(51) Int. Cl. G02B 6/02

(52) U.S. Cl. CPC G02B 6/02395

(57) ABSTRACT

The glass optical waveguide body contains an optical waveguide and has undergone a chemical strengthening, and when it is used as a cover glass or the like, the glass optical waveguide body has high resistance against scratching and cracking and can enhance its design qualities by displaying an image by the optical waveguide in a state of floating.

### TECHNICAL FIELD

The present invention relates to a glass optical waveguide body and a cover glass.

### BACKGROUND ART

Conventionally, there have been known display devices having a touch panel function (e.g. mobile phones, personal digital assistants (PDAs), tablet PCs). Each of such display devices is so structured that a touch sensor-equipped glass substrate is placed on a liquid crystal display (LCD) and a cover glass is further mounted on the glass substrate for the purpose of protecting the display device.

Patent Document 1 discloses that a fiber-optic bundle obtained by tying optical plastic fibers in a bundle is installed as a protective cover on a display screen of an apple-shaped electrooptic device and further the bundle is processed so as to have a curved surface, and thereby images displayed in planar form can be displayed in a state of floating up to the curved surface, and besides, it becomes possible to adopt highly sophisticated designs making various use of curved surfaces.

### PRIOR ART DOCUMENT

### Patent Document

Patent Document 1: JP-A-2008-176092

### SUMMARY OF THE INVENTION

### Problems that the Invention is to Solve

However, the protective cover as described in Patent Document 1, which contains a fiber-optic bundle obtained by tying optical plastic fibers in a bundle, tends to get scratches on the surface. In particular, in the case of a mobile terminal such as a mobile phone, a smart phone or a mobile PC, or a touch sensor-equipped display device, the protective cover threatens to suffer damage at an early stage due to a flaw generated by dropping or scratching during use.

On the other hand, glass optical fibers also have been known conventionally. However, it hasn't been conceived that they might be used as protective covers, and hence they have room for improvement when intended for use as protective covers of mobile terminals or touch sensor-equipped display devices.

The invention therefore aims to provide a glass optical waveguide body and a cover glass which have high resistance against scratching and cracking while ensuring enhancement of their design qualities.

### Means for Solving the Problems

The present invention provides the following aspects:
(1) A glass optical waveguide body, containing an optical waveguide and having undergone a chemical strengthening;
(2) The glass optical waveguide body according to (1), in which the optical waveguide contains a core which is enclosed by a cladding and has a refractive index greater than that of the cladding;
(3) The glass optical waveguide body according to (1) or (2), formed by fusion-bonding a fiber-optic bundle prepared by tying a plurality of optical fibers with a core-cladding structure;
(4) The glass optical waveguide body according to any one of (1) to (3), having a light incident surface and a light emitting surface, in which the light emitting surface has a curved shape;
(5) The glass optical waveguide body according to (2), in which the cladding contains a coloring ingredient;
(6) The glass optical waveguide body according to any one of (1) to (5), which is a cover glass;
(7) A glass optical waveguide body, formed by fusion-bonding a fiber-optic bundle prepared by tying a plurality of optical fibers with a core-cladding structure, and further receiving a chemical strengthening;
(8) A cover glass having a light incident surface and a light emitting surface, in which the cover glass contains an optical waveguide and has undergone a chemical strengthening, and in which the light emitting surface has a curved shape;
(9) The cover glass according to (8), in which the optical waveguide contains core which is enclosed by a cladding and has a refractive index greater than that of the cladding; and
(10) The cover glass according to (9), in which the cladding contains a coloring ingredient.

### Advantage of the Invention

According to the glass optical waveguide body as described in (1), the glass optical waveguide body can be enhanced in strength because the glass optical waveguide body has undergone a chemical strengthening. Supposing the glass optical waveguide body is used as a cover glass, it can exhibit high resistance against scratching and cracking, and besides, images can be displayed in a state of being floated up by the optical waveguide, and the design quality can be enhanced. The term “optical waveguide” as used in the present invention means the optical transmission section formed by taking advantage of a refractive index difference between two types of glasses.

According to the glass optical waveguide body as described in (2), it is able to show light rays emitted from the optical waveguide more clearly.

According to the glass optical waveguide body as described in (3), a glass optical waveguide body having a plurality of optical waveguides can be manufactured with ease.

According to the glass optical waveguide body as described in (4), a light emitting surface can be formed into a curved shape without causing stress produced by bending glass, and hence the design quality thereof can be more enhanced.

According to the glass optical waveguide body as described in (5), it is able to enhance the contrast, against a background area, of light rays emitted from the optical waveguides.

According to the glass optical waveguide body as described in (6), a cover glass which exhibits high resistance against scratching and cracking and possesses high-quality design can be provided.

According to the glass optical waveguide body as described in (7), the glass optical waveguide body can be made from a fiber-optic bundle. In addition, the glass optical waveguide body can be improved in strength because the glass optical waveguide body has undergone a chemical strengthening.

According to the cover glass as described in (8), images can be displayed in a state of floating up by the optical waveguide, and besides, the light emitting surface can be formed into a curved shape without causing stress produced by bending glass, and hence the design quality can be more enhanced. Moreover, the cover glass can be improved in strength because it has undergone a chemical strengthening.

According to the cover glass as described in (9), it is able to show light rays emitted from the optical waveguide more clearly.

According to the cover glass as described in (10), it is able to enhance the contrast, against a background area, of light rays emitted from the optical waveguides.

### BRIEF DESCRIPTION OF THE DRAWINGS

FIG. 1 is a schematic diagram of a liquid crystal display device in which the glass optical waveguide body according to the present invention is used as a cover glass.

FIG. 2 is a schematic diagram of a liquid crystal display device in which the glass optical waveguide body according to the present invention is used as a decoration member forming a part of its housing.

FIG. 3 is a schematic diagram illustrating a method for producing a glass optical waveguide body of a first embodiment.

FIG. 4 is a schematic diagram illustrating a method for producing a glass optical waveguide body of a second embodiment.

FIG. 5 is a schematic diagram illustrating a method for producing a glass optical waveguide body of a third embodiment.

FIG. 6 is a schematic diagram illustrating a method for producing a glass optical waveguide body of a fourth embodiment.

### MODES FOR CARRYING OUT THE INVENTION

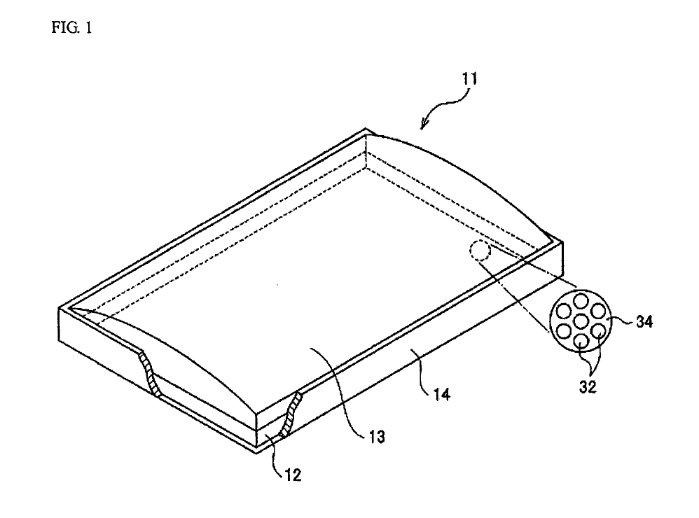

In the first place, an embodiment is illustrated in which the glass optical waveguide body of the present invention is used as a cover glass of a display device. FIG. 1 is a schematic diagram of a liquid crystal display device.

The liquid crystal display device (hereinafter also referred to as “LCD device”) 11 includes, as illustrated in FIG. 1, a liquid crystal display panel 12, a cover glass 13 and a housing 14 which accommodates these liquid crystal display panel 12 and cover glass 13. The cover glass 13 has about the same size as the liquid crystal display panel 12, and users visually recognize the display on the liquid crystal display panel 12 via the cover glass 13.

### Liquid Crystal Display Panel

The liquid crystal display panel 12 may have a general structure, in which a liquid crystal layer is provided between two glass substrates and, on the inner surface of one glass substrate situated on the screen (light emitting surface) side, a transparent electrode film, color filters (CF) and so on are provided in established order. On the other hand, on the inner surface of the other glass substrate situated on the back (light incident surface) side, a transparent electrode film, a semiconductor element (e.g. TFT) and so on are provided in established order. On each of the outer surfaces of these glass substrates, a polarizing filter is mounted.

In the liquid crystal display panel 12, application of voltage to the liquid crystal layer through the transparent electrode films brings about a change in the direction of alignment in the liquid crystal layer, and thereby an image is displayed. The liquid crystal display panel 12 has no particular restrictions as to its driving system, and examples thereof include TN, STN, FE, TFT, MIM, IPS and VA.

### Cover Glass

The cover glass 13 is usually mounted for the purposes of increasing the strength of the LCD device 11, preventing fracture by shock and so on. In addition to these purposes, the cover glass is used in this embodiment for the purpose of enhancing the design quality.

The cover glass 13 has a core-cladding structure including cores 32 and cladding 34 in which the cladding 34 is interspersed with a plurality of cores 32 which each extend from the back side toward the display surface side. In other words, each core 32 is present in the cladding 34 in a state of being encompassed by the cladding 34. Core 32 has a higher refractive index than that of a cladding 34 and, by this difference in refractive index, light propagates through the interior of each core 32 encompassed by the cladding 34 while repeating total reflection. In other words, the cores 32 function as optical waveguides and transmit light. Thus images displayed on the liquid crystal display panel 12 are visually recognized by users via the cores 32 which form the optical waveguides, and the images are seen by users as if to float up to the display surface of the cover glass 13.

In addition, the cover glass 13 is formed so as to have a curved display surface. For making a traditional cover glass to have a curved surface, bending stress is necessarily applied to the cover glass. Such a process has various problems. For instance, a thin cover glass to which bending stress has been applied cracks easily on slight impact. For keeping a traditional cover glass in a curved state against its resilience, it is required to use a housing high in rigidity. In addition, because it is necessary for a cover glass to guide backlight by repeating total reflection, if the cover glass is bent so as to have a radius of curvature beyond a certain degree, anomalous light leakage occurs. In contrast to traditional cover glasses, the cover glass 13 of the present invention can be formed so that its display surface has a curved shape without application of bending stress, and thereby all the foregoing problems the traditional cover glasses have can be solved. Further, images displayed on the liquid crystal display panel 12 can be projected onto the light emitting surface in curved shape, and it is possible to show them as if they are displayed on the curved surface.

The thickness of the cover glass 13 is 1.5 mm or less, more preferably 1.0 mm or less, and further preferably 0.8 mm or less. Although various types of glass, such as aluminosilicate glass, soda lime glass and aluminoborosilicate glass are usable, glass having e.g. a chemical composition of the following can be favorably used.

(i) Glass of a chemical composition containing, as expressed in % by mole, 50% to 80% of SiO₂, 2% to 25% of Al₂O₃, 0 to 20% of Li₂O, 0 to 20% of Na₂O, 0 to 10% of K₂O, 0 to 15% of MgO, 0 to 5% of CaO, and 0 to 5% of ZrO₂. Herein, the wording “containing 0 to 10% of K₂O”, for example, means that K₂O, though it is not an essential component, may be present in a proportion up to 10% within a range not to impair the aims of the invention.

(ii) Glass of a chemical composition containing, as expressed in % by mole, 50% to 74% of SiO₂, 1% to 10% of Al₂O₃, 6% to 18% of Na₂O, 3% to 11% of K₂O, 2% to 15% of MgO, 0 to 6% of CaO, and 0 to 5% of ZrO₂, and that having the sum of the contents of SiO₂ and Al₂O₃ in a range of 75% or less, the sum of the contents of Na₂O and K₂O in a range of 12% to 25% and the sum of the contents of MgO and CaO in a range of 7% to 15%.

(iii) Glass of a chemical composition containing, as expressed in % by mole, 68% to 80% of SiO₂, 4% to 10% of Al₂O₃, 5 to 18% of Na₂O, 0 to 1% of K₂O, 4 to 15% of MgO, and 0 to 1% of ZrO₂.

(iv) Glass of a chemical composition containing, as expressed in % by mole, 67% to 75% of SiO₂, 0 to 4% of Al₂O₃, 7% to 15% of Na₂O, 1% to 9% of K₂O, 6% to 14% of MgO, and 0 to 1.5% of ZrO₂, and that having the sum of the contents of SiO₂ and Al₂O₃ in a range of 71% to 75%, the sum of the contents of Na₂O and K₂O in a range of 12% to 20% and a CaO content of lower than 1% in the case of containing CaO.

Herein, by forming the glass to form the cladding 34 by adjusting the content of an element having a large specific gravity (e.g. ZrO₂) to be low and the content of an element having a small specific gravity (e.g. MgO) to be high as compared with those in the glass to form the core 32, the refractive index of the core 32 can be made higher than that of the cladding 34. In this way, the core 32 and the cladding 34 which are different in refractive index can be formed from two types of glasses different in chemical composition. However, the core 32 and the cladding 34 may be formed from more than two types of glasses. Further, a coloring ingredient may be added to the cladding 34 that does not form optical waveguide. By the addition of a coloring ingredient, the contrast between light rays emitted from optical waveguide and the background area can be heightened. Examples of a coloring ingredient which may be added include Co, Mn, Fe, Ni, Cu, Cr, V, Zn, Bi, Er, Tm, Nd, Sm, Sn, Ce, Pr, Eu, Ag and Au. In such a case, the total amount of coloring ingredients added is typically 5% or lower as expressed % by mole based on oxides of metals with minimum valence numbers. In particular, each of CoO, NiO and Cr₂O₃ is preferably in a range of 0.0001% to 0.1%. Each of FeO, CuO, Er₂O₃, Nd₂O₃, Sm₂O₃ and CeO is preferably in a range of 0.001% to 2%.

The core size is preferably from 1 to 1,000 μm. In the case of smaller than 1 μm, there is a concern of occurrence of light leakage from a core into a cladding region, and thereby contrast might be lowered, or brightness might be lowered. Thus the core size is preferably 5 μm or more, and further preferably 30 μm or more. On the other hand, in the case of larger than 1,000 μm, pixels displayed in a liquid crystal display panel are made coarse. Thus the core size is preferably 500 μm or smaller, and further preferably 300 MPa or smaller. In order for making use in a high-definition liquid crystal display panel, it is 200 μm or smaller, more preferably 100 μm or smaller, and further preferably 80 μm or smaller. Incidentally, the term core size means e.g. the core diameter in the case where each core has a circular shape in planar view, or means the length of one side in the case where each core has a square shape in planar view.

The chemical strengthening is carried out e.g. by immersing glass in a molten potassium nitrate (KNO₃) salt at a temperature of 380° C. to 450° C. over a time period of 0.1 hr to 20 hr. The level of the chemical strengthening can be controlled by making changes in temperature of the molten potassium nitrate (KNO₃) salt, immersion time, kind of a molten salt and/or so on. By giving chemical strengthening to glass, a compressive stress layer is formed on the surface and a tensile stress layer is formed interior.

The compressive stress layer CS has a compressive stress of preferably 300 MPa or larger, more preferably 500 MPa or larger, and further preferably 700 MPa or larger. The depth of the compressive stress layer (DOL) is preferably 10 μm or larger, and more preferably 20 μm or larger.

The cover glass 13 is stuck on the side of the display surface side of the liquid crystal display panel 12 through a light-transmissive adhesive film placed on the display surface side of the liquid crystal display panel 12. The adhesive film may have a general constitution, and its material properties and shape can be chosen as appropriate.

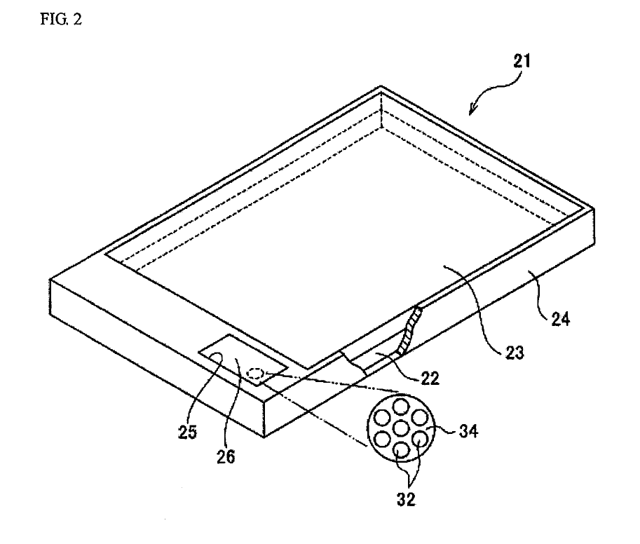

In the embodiment illustrated in FIG. 1, the use of a glass optical waveguide body as a cover glass is illustrated. However, it is not limited to this embodiment but can also be used as a decoration member forming a part of its housing. FIG. 2 is a schematic diagram of a liquid crystal display device in which a glass optical waveguide body is used as a decoration member forming a part of its housing.

A liquid crystal display device (hereinafter also referred to as “LCD device”) 21 includes, as illustrated in FIG. 2, a liquid crystal display panel 22, a cover glass 23 and a housing 24 which accommodates the liquid crystal display panel 22 and the cover glass 23. The cover glass 23 has about the same size as the liquid crystal display panel 22, and users visually recognize the display on the liquid crystal display panel 22 via the cover glass 23.

The liquid crystal display panel 22 is identical to the liquid crystal display panel 12 except for the size, and hence explanation thereof is omitted. The cover glass 23 may adopt a core-cladding structure similarly to the foregoing embodiment, or may be a cover glass made of chemically strengthened glass which is uniform without adopting a core-cladding structure. The display surface may be formed into a curved shape, or may be formed into a planar shape.

The housing 24 in this embodiment has a window section 25 formed in a lower part thereof, and the decoration member 26 including a glass optical waveguide body is embedded in part of the window section. On the bottom surface of the window section 25 of the housing 24 in which the decoration member 26 is embedded, a logo, a device name, a maker name and so on, which are not shown in the figure, are printed.

### Decoration Member

The decoration member 26 has a core-cladding structure including the cores 32 and the cladding 34, and the cladding 34 is interspersed with a plurality of cores 32 which each extend from the bottom surface side of the housing toward the display surface side. In other words, each core 32 is present in the cladding 34 in a state of being encompassed by the cladding 34. The cores 32 has a larger refractive index than that of the cladding 34 and, by this difference in refractive index, light propagates through the interior of each core 32 encompassed by the cladding 34 while repeating total reflection. In other words, the cores 32 function as optical waveguides and transmit light. Thus a logo and the like printed on the bottom surface of the window section 25 are visually recognized by users via the cores 32 which form the optical waveguides, and the images are seen by users as if to float up. Incidentally, the display surface of the decoration member 26 may have a planar shape, or may have a curved shape. Further, only one core may be present, and in the case of a single core, a color printed on the bottom surface looks as if a dot floats up. Glass types, chemical strengthening methods, coloring ingredients and so on are identical to those adopted in the cover glass 13 explained in the foregoing embodiment, and explanations thereof are therefore omitted.

Next, methods for manufacturing a glass optical waveguide body as the cover glass 13 or as the decoration member 26 according to the present invention are described.

### First Example

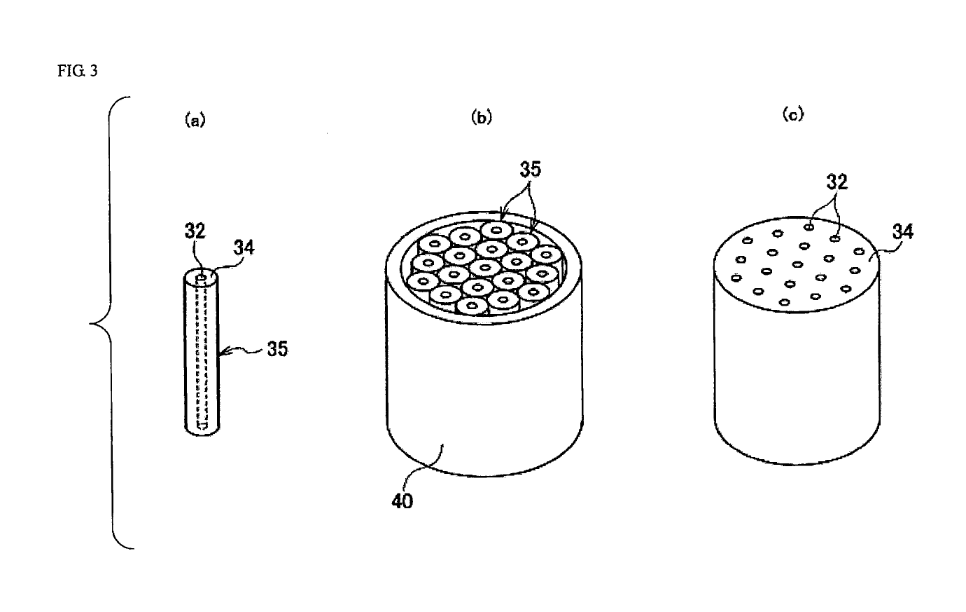

In a first example, an optical fiber 35 as a preform made up of a core 32 and cladding 34 is formed first as illustrated in (a) of FIG. 3. Formation of the optical fiber 35 can be achieved e.g. by producing a core and hollow cladding separately, placing the core inside the cladding tube, and then fusion-bonding them together in a vacuum; by using a crucible of dual structure, putting glass to form a core into the inner crucible and putting glass to form cladding into the outer crucible, respectively, melting them at a high temperature, and then drawing out them simultaneously from the bottom of the crucibles; or by adopting an internal or external CVD method.

Subsequently, a plurality of optical fibers 35 having the core-cladding structure are tied into a bundle by means of a ceramic jig 40 and fusion-bonded together by heating in a vacuum ((b) of FIG. 3), thereby forming a fiber-optic bundle, namely a glass optical waveguide body having a structure that the cladding 34 is interspersed with the plurality of cores 32 ((c) of FIG. 3).

### Second Example

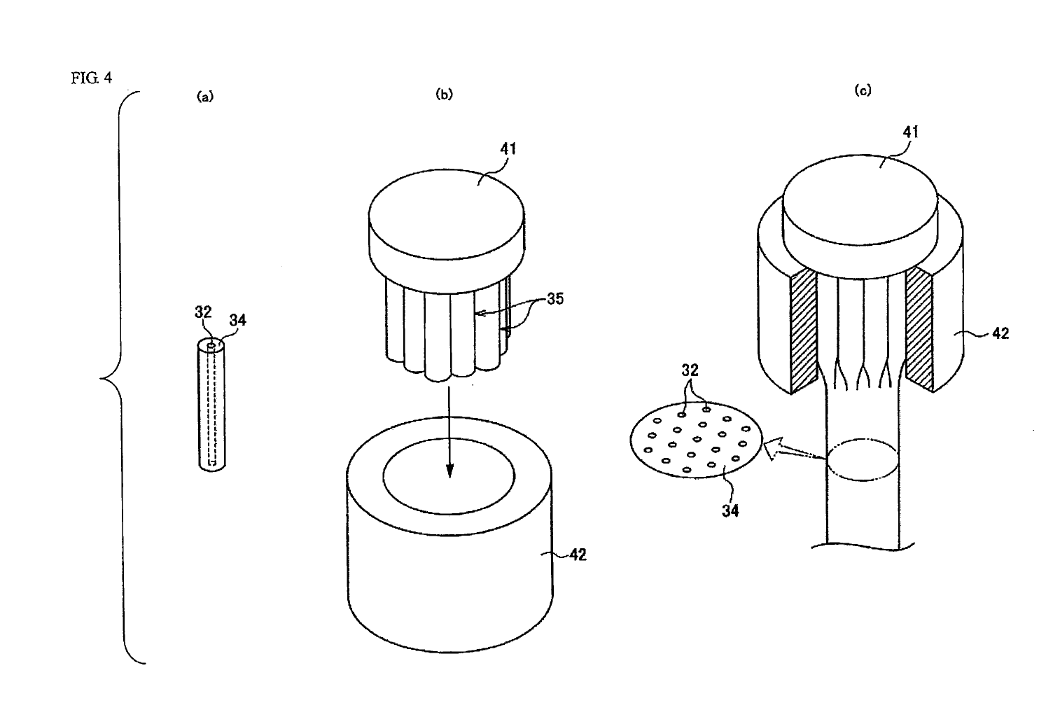

In a second example, similar to (a) of FIG. 3, an optical fiber made up of a core and cladding is formed first ((a) of FIG. 4). A plurality of optical fibers having the core-cladding structure are tied in a bundle and held from above by means of a jig 41, and then drawn as they are heated with a cylindrical-shaped electric furnace 42 ((b) of FIG. 4), thereby forming a fiber-optic bundle, namely a glass optical waveguide body having a structure that the cladding 34 is interspersed with the plurality of cores 32 ((c) of FIG. 4).

### Third Example

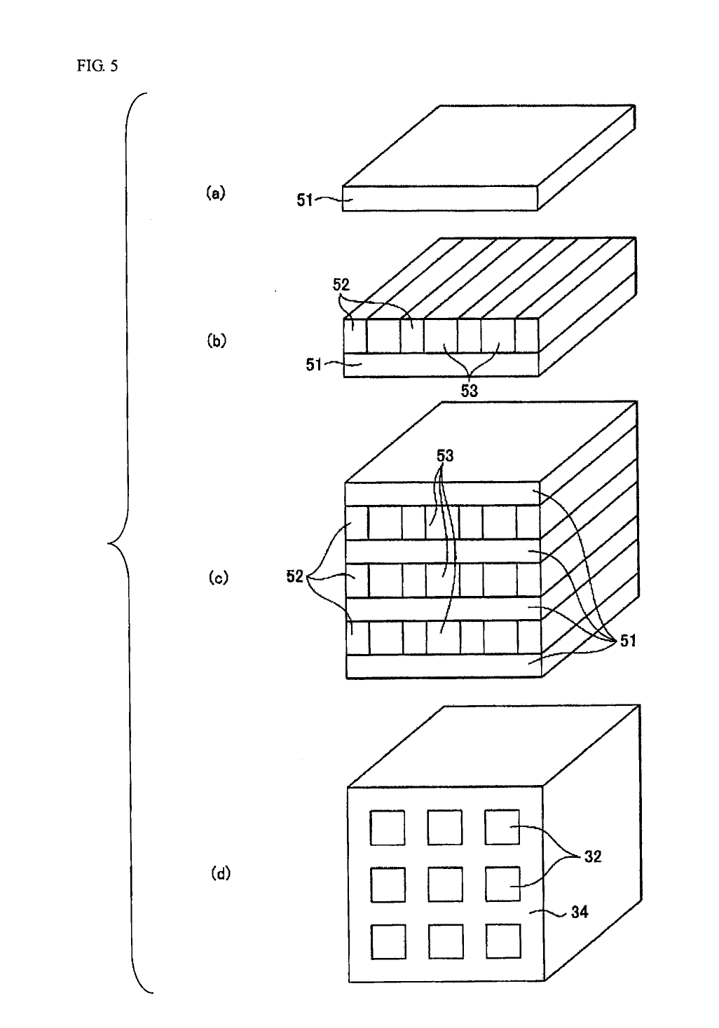

In a third example, as illustrated in (a) of FIG. 5, a rectangular-shaped first block 51 having a horizontally long cross section is firstly prepared for cladding, and then on the first block 51, as illustrated in (b) of FIG. 5, rectangular-shaped second blocks 52 to form cladding, which are vertically somewhat long in cross section, and rectangular-shaped third blocks 53 to form cores, which are nearly square in cross section, are placed alternately. Subsequently, another first block 51 is loaded on the second blocks 52 and the third blocks 53, and further thereon other second blocks 52 and other third blocks 53 are placed alternately. Such a stacking operation is repeated until an assembly having the intended area is formed ((c) of FIG. 5), and they are fusion-bonded theretogether, thereby forming a glass optical waveguide body having a structure that the cladding 34 is interspersed with the plurality of cores 32 ((d) of FIG. 5).

### Fourth Example

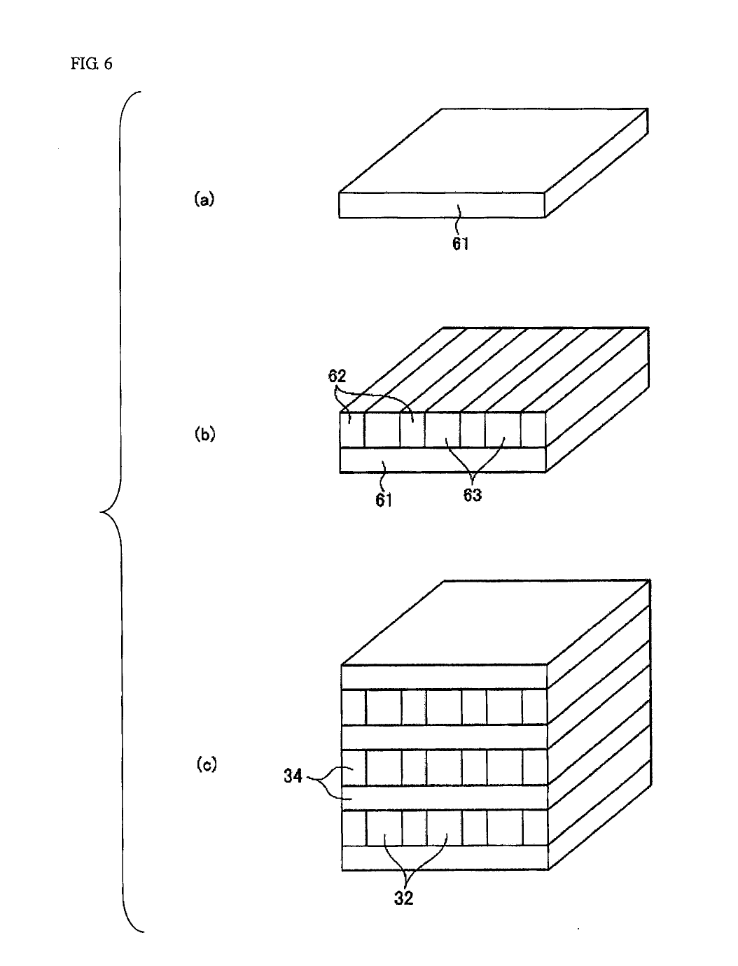

In a fourth example, as illustrated in (a) of FIG. 6, glass 61 to form cladding is firstly made by sputtering, and thereon, as illustrated in (b) of FIG. 6, glass 62 to form cores and glass 63 to form cladding are sputtered so as to be aligned alternately in the direction of the length. Thereon, another glass 61 to form cladding is sputtered and, further thereon another glass 62 to form cores and another glass 63 to form cladding are sputtered so as to be aligned alternately in the direction of the length. By repeating such sputtering operations, a glass optical waveguide body having a structure that the cladding 34 is interspersed with a plurality of cores 32 ((c) of FIG. 6) is formed.

In addition, the glass optical waveguide bodies made in the third example or the fourth example may be held alone or in a plurality thereof in a bundle and, as in the second example, drawn under heating with an electric furnace, thereby forming a modified glass optical waveguide body having a structure that the cladding is interspersed with a plurality of cores.

The glass optical waveguide body formed according to the method as illustrated in each of first to fourth examples is cut to the size and the thickness suitable for the cover glass 13 or the decoration member 26, and shaped by polishing or the like so as to have e.g. a curved surface in its external appearance. Thereafter, a chemical strengthening treatment is carried out. The chemical strengthening treatment is such a treatment as to cause replacement of alkali metal ions having small ion radii (examples of which include ions of Li and Na) present at the surface of glass with alkali ions having larger ion radii (examples of which include ions of K) through the ion exchange at a temperature not higher than the glass transition temperature, thereby forming a compressive stress layer on the surface of the glass and a tensile stress layer in the interior of the glass. For example, the chemical strengthening is performed by immersing in a molten potassium nitrate (KNO₃) salt at a temperature of 425° C. to 465° C. for 2 to 6 hours.

Additionally, when the area of the glass optical waveguide body formed by the method illustrated in the first to fourth example is smaller than that of the cover glass 13 or the decoration member 26, it is possible to obtain a larger-area glass optical waveguide body by arranging a plurality of glass optical waveguide bodies obtained and fusion-bonding them together in a vacuum. The number, shape and size of cores forming optical waveguides, the proportion between cores and cladding and the like can be chosen arbitrarily. In addition, the transmittance can be controlled by adjusting the degree of vacuum or by admitting air into the glass optical waveguide body at the time of fusion-bonding in the air.

### EXAMPLES

Example of the invention is illustrated below.

To begin with, glass A to form cores and glass B to form cladding are prepared. The chemical composition of each glass is as follows.

### Glass A

SiO₂: 64.5%

Al₂O₃: 6%

MgO: 11%

ZrO₂: 2.5%

Na₂O: 12%

K₂O₄: 4%

### Glass B

SiO₂: 64.5%

Al₂O₃: 6%

MgO: 12%

ZrO₂: 1.5%

Na₂O: 12%

K₂O₄: 4%

Optical fibers with core-cladding structure are formed from the glass A and the glass B, and a plurality of the optical fibers are tied in a bundle and integrated into one body, followed by cutting and grinding treatment, thereby making a glass optical waveguide body having a curved shape. This glass body is chemically strengthened by 6-hour immersion in a molten potassium nitrate (KNO₃) salt at 450° C. Thus a glass optical waveguide body having a compressive stress of 1,023 MPa and having a compressive stress depth of 46 μm is obtained by the chemical strengthening.

Incidentally, the present invention should not be construed as being limited to the foregoing embodiment in any way, and can be carried out in various modes without departing from the scope and spirit of the invention.

The glass optical waveguide body can be used for a wide variety of applications including toys, advertisements and so on, in addition to as a cover glass and a decoration member which forms a part of housing.

The present application is based on Japanese Patent Application No. 2012-176325, filed on Aug. 8, 2012, and the contents thereof are incorporated herein by reference.

### DESCRIPTION OF REFERENCE NUMERALS

11, 21 Liquid crystal display device
12, 22 Liquid crystal display panel
13, 23 Cover glass (glass optical waveguide body)
14, 24 Housing
26 Decoration member (glass optical waveguide body)
32 Core
34 Cladding

1. A glass optical waveguide body, comprising an optical waveguide and having undergone a chemical strengthening.

2. The glass optical waveguide body according to claim 1, wherein the optical waveguide contains a core which is enclosed by a cladding and has a refractive index greater than that of the cladding.

3. The glass optical waveguide body according to claim 1, formed by fusion-bonding a fiber-optic bundle prepared by tying a plurality of optical fibers with a core-cladding structure.

4. The glass optical waveguide body according to claim 1, having a light incident surface and a light emitting surface, wherein the light emitting surface has a curved shape.

5. The glass optical waveguide body according to claim 2, wherein the cladding contains a coloring ingredient.

6. The glass optical waveguide body according to claim 1, which is a cover glass.

7. A glass optical waveguide body, formed by fusion-bonding a fiber-optic bundle prepared by tying a plurality of optical fibers with a core-cladding structure, and further receiving a chemical strengthening.

8. A cover glass having a light incident surface and a light emitting surface, wherein the cover glass comprises an optical waveguide and has undergone a chemical strengthening, and wherein the light emitting surface has a curved shape.

9. The cover glass according to claim 8, wherein the optical waveguide contains core which is enclosed by a cladding and has a refractive index greater than that of the cladding.

10. The cover glass according to claim 9, wherein the cladding contains a coloring ingredient.
